(19) United States
(12) Patent Application Publication
(10) Pub. No.: US 2008/0129024 A1
(43) Pub. Date: Jun. 5, 2008

(54) Airbag apparatus

(75) Inventors: Shigeyuki Suzuki, Aichi-ken (JP); Kenji Fujimura, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD, Aichi-Ken (JP)

(21) Appl. No.: 11/987,397

(22) Filed: Nov. 29, 2007

(30) Foreign Application Priority Data
Nov. 30, 2006 (JP) 2006-322931
Apr. 5, 2007 (JP) 2007-099553

(51) Int. Cl. B60R 21/20; B60R 21/237

(52) U.S. Cl. 280/734; 280/743.1

(57) ABSTRACT

An airbag apparatus for a vehicle includes an airbag provided in a center console extending along a longitudinal direction of the vehicle. In a collision of the vehicle, the airbag is inflated and deployed between the driver's seat and the center console and/or between the passenger seat and the center console. Alternatively, the airbag is inflated and deployed between the seat back of the driver's seat and the seat back of the passenger seat.

### BACKGROUND OF THE INVENTION

The present invention relates to an airbag apparatus, and more particularly to an airbag apparatus having an airbag that is inflated and deployed at a collision of a vehicle in the vicinity of a center console extending along the vehicle longitudinal direction in the passenger compartment.

Known types of such airbag apparatuses include the ones disclosed, for example, in Japanese Laid-Open Patent Publication No. 2004-217109 and Japanese Laid-Open Utility Model Publication No. 5-3055. FIG. 12 shows a typical example of such a conventional airbag apparatus that is disclosed in the above publications. As shown in FIG. 12, a center console 110, which extends along the vehicle longitudinal direction, is provided in the passenger compartment. The center console 110 has a console box 112, which has a container V1 in it. An airbag 120 is accommodated inside the console box 112. In a vehicle collision, the airbag 120 receives gas generated by an inflator, and is inflated and deployed upward out of the console box 112, so as to be upright. The thus inflated and deployed airbag 120 restrains an occupant P on a seat, who, due to the impact of the collision, is moved in such a manner as to fall onto the center console 110.

However, since the airbag 120 is held upright while only its proximal end (lower end) is supported by the vehicle, the airbag 120 can collapse due to the pressure applied by the occupant P when the occupant P on the seat is moved in such a manner as to fall onto the center console 110. As a result, the airbag 120 can fail to properly restrain the occupant P.

### SUMMARY OF THE INVENTION

Accordingly, it is an objective of the present invention to provide an airbag apparatus that reliably restrains an occupant with an airbag while suppressing falling of the airbag.

To achieve the foregoing objective and in accordance with one aspect of the present invention, an airbag apparatus for a vehicle is provided. The vehicle has in a passenger compartment a seat and a center console, which extends along a longitudinal direction of the vehicle. The apparatus includes an airbag provided in the center console. In a collision of the vehicle, the airbag is inflated and deployed between the seat and the center console.

In accordance with another aspect of the present invention, an airbag apparatus for a vehicle is provided. The vehicle has in a passenger compartment a center console, which extends along a longitudinal direction of the vehicle, and first and second seats, which each have a seat back and are provided on both sides of the center console. The apparatus includes an airbag provided in the center console. In a collision of the vehicle, the airbag is inflated and deployed between the seat back of the first seat and the seat back of the second seat.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a schematic front view illustrating an airbag apparatus according to a first embodiment of the present invention, in a state where an airbag is inflated and deployed;

FIG. 1B is a schematic perspective view illustrating the airbag apparatus shown in FIG. 1A, in a state where the airbag is inflated and deployed;

FIG. 2A is a cross-sectional view illustrating an airbag apparatus according to a second embodiment of the present invention, in a state where an airbag is yet to be inflated and deployed;

FIG. 2B is a cross-sectional view illustrating the airbag apparatus shown in FIG. 2A, in a state where the airbag is inflated and deployed;.

FIG. 3 is a side view illustrating a second airbag portion of an airbag apparatus according to a third embodiment of the present invention;

FIG. 4A is a cross-sectional view taken along line A-A of FIG. 3;

FIG. 4B is a cross-sectional view illustrating a state in which the second airbag portion of FIG. 3 is being inflated and deployed;

FIG. 4C is a cross-sectional view illustrating a state in which the second airbag portion of FIG. 3 is completely inflated and deployed;

FIG. 5 is a side view illustrating an airbag apparatus according to a fourth embodiment of the present invention, in a state where an airbag is inflated and deployed;

FIG. 6 is a side view illustrating an airbag apparatus according to a fifth embodiment of the present invention, in a state where an airbag is inflated and deployed;

FIG. 7 is a cross-sectional view taken along line B-B of FIG. 6;

FIG. 8 is a schematic front view illustrating a moving mechanism of an airbag apparatus according to another embodiment of the present invention;

FIGS. 9, 10, and 11 are each a schematic perspective view illustrating an airbag apparatus according to a further embodiment of the present invention; and

FIG. 12 is a schematic front view illustrating a prior art airbag apparatus.

### DETAILED DESCRIPTION OF THE PREFERRED EMBODIMENTS

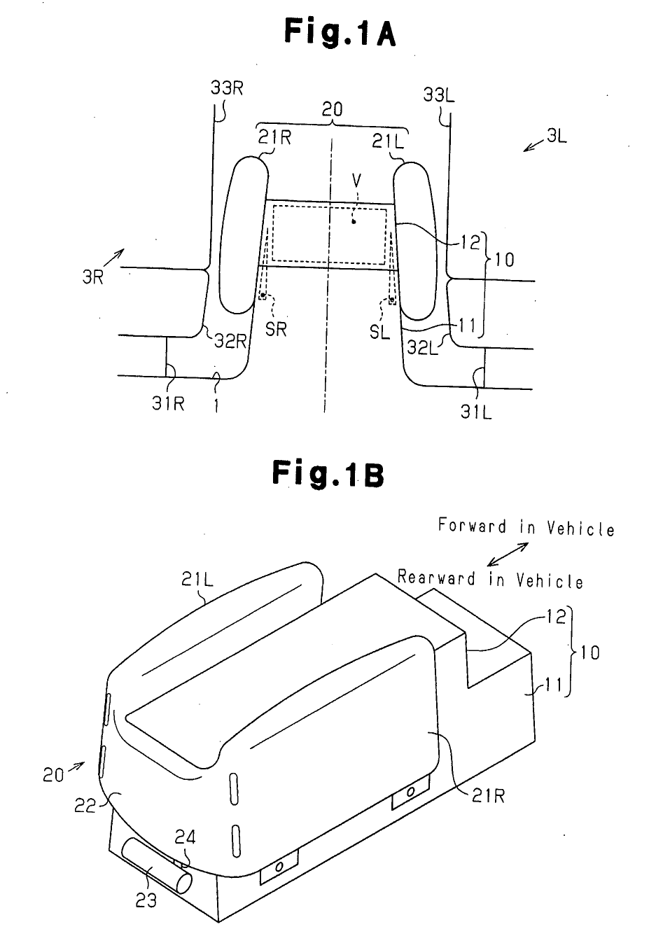

A first embodiment of the present invention will now be described with reference to FIGS. 1A and 1B. An airbag apparatus according to the present embodiment has an airbag 20 that corresponds to a driver's seat 3R and a front passenger seat 3L, which are vehicle front seats, and is designed for restraining occupants seated on the driver's seat 3R and the passenger seat 3L in a side collision.

As shown in FIG. 1, a center console 10, which extends along the vehicle longitudinal direction, is provided between the driver's seat 3R and the passenger seat 3L in the passenger compartment. The driver's seat 3R and the passenger seat 3L are installed on rail units 31R, 31L located on a floor surface 1 of the passenger compartment so as to be movable in the vehicle longitudinal direction. The driver's seat 3R has a seat cushion 32R for supporting the buttocks of an occupant seated on the driver's seat 3R, and a reclining seat back 33R for supporting the back of the occupant. The passenger seat 3L has a seat cushion 32L for supporting the buttocks of an occupant seated on the passenger seat 3L, and a reclining seat back 33L for supporting the back of the occupant.

The center console 10 includes a console main body 11, which extends upright from the floor surface 1 of the passenger compartment, and a console box 12 attached onto the console main body 11. The interior of the console box 12 has a container V. The height of the upper surface of the console main body 11 is substantially the same as the height of the upper surfaces of the seat cushions 32R, 32L, and the console box 12 is at a position higher than the upper surfaces of the seat cushions 32R, 32L. The console main body 11 and the console box 12 are both made of a resin material. A hollow portion SR, SL, which is independent from the container V, is formed in a portion of the center console 10 that is located about the container V of the console box 12. An airbag 20, which is yet to be inflated and deployed, is accommodated in the hollow portion SR, SL.

As shown in FIG. 1B, the airbag 20 includes a first airbag portion 21R, which is inflated and deployed in the vicinity of the driver's seat 3R to restrain an occupant seated on the driver's seat 3R, a second airbag portion 21L, which is inflated and deployed in the vicinity of the passenger seat 3L to restrain an occupant seated on the passenger seat 3L, and a connection portion 22, which is located between the first and second airbag portions 21R, 21L to connect the airbag portions 21R and 21L to each other. An inflator 23, which generates gas to be supplied to the airbag 20, is located on the back side of the center console 10.

When a great impact applied to the vehicle is detected by a sensor, the inflator 23 generates gas. The gas from the inflator 23 is first conducted to the connection portion 22 through an inlet passage 24, and is then supplied to the first airbag portion 21R and the second airbag portion 21L. Accordingly, as shown in FIG. 1A, the first airbag portion 21R is inflated and deployed along a side surface of the center console 10 that faces the driver's seat 3R in the vehicle width direction, and between the center console 10 and the driver's seat 3R. Likewise, the second airbag portion 21L is inflated and deployed along a side surface of the center console 10 that faces the passenger seat 3L in the vehicle width direction, and between the center console 10 and the passenger seat 3L. To allow the airbag 20 pop out of the hollow portion SR, SL of the center console 10, the outer side wall of the center console 10 has such a strength that the outer side wall is breakable by the airbag 20 when the airbag 20 is being inflated and deployed.

The present embodiment has the following advantages.

The first portion 21R of the airbag 20 is inflated and deployed between the center console 10 and the driver's seat 3R, and the second portion 21L of the airbag 20 is inflated and deployed between the center console 10 and the passenger seat 3L. Therefore, in a vehicle collision, even if an occupant on the driver's seat 3R is moved in such a manner as to fall onto the center console 10, and as a result, applies a force in the vehicle width direction to the first airbag portion 21R, the first airbag portion 21R is prevented from falling since the first airbag portion 21R receives a reaction force from the side surface of the center console 10 that faces the driver's seat 3R in the vehicle width direction. Likewise, in a vehicle collision, even if an occupant on the passenger seat 3L is moved in such a manner as to fall onto the center console 10, and as a result, applies a force in the vehicle width direction to the second airbag portion 21L, the second airbag portion 21L is prevented from falling since the second airbag portion 21L receives a reaction force from the side surface of the center console 10 that faces the passenger seat 3L in the vehicle width direction. Therefore, the airbag apparatus according to the present embodiment reliably restrains an occupant with the airbag 20, while preventing the airbag 20 from falling.

The center console 10 has the console box 12, which has the container V in it. Therefore, the side surfaces of the center console 10 are larger than those in the case in which no console box 12 is provided by the amount corresponding to the size of the console box 12. Therefore, in a vehicle collision, even if an occupant on the driver's seat 3R or the passenger seat 3L is moved in such a manner as to fall onto the center console 10, and as a result, applies a force in the vehicle width direction to the airbag 20, the airbag 20 is reliably prevented from falling since the airbag 20 receives a great reaction force from the side surface of the center console 10.

Since the hollow portion SR, SL of the center console 10 for accommodating the airbag 20 prior to inflation and deployment is independent from the container V of the console box 12, the function of the console box 12 to accommodate small articles is not impaired by the provision of the airbag 20 in the center console 10.

Since the first portion 21R and the second portion 21L of the airbag 20 are connected to each other by the connection portion 22, the airbag portions 21R and 21L are inflated and deployed by the supply of gas from the common inflator 23. Since the single inflator 23 is used for both of the first airbag portion 21R and the second airbag portion 21L, the airbag apparatus has a simplified structure.

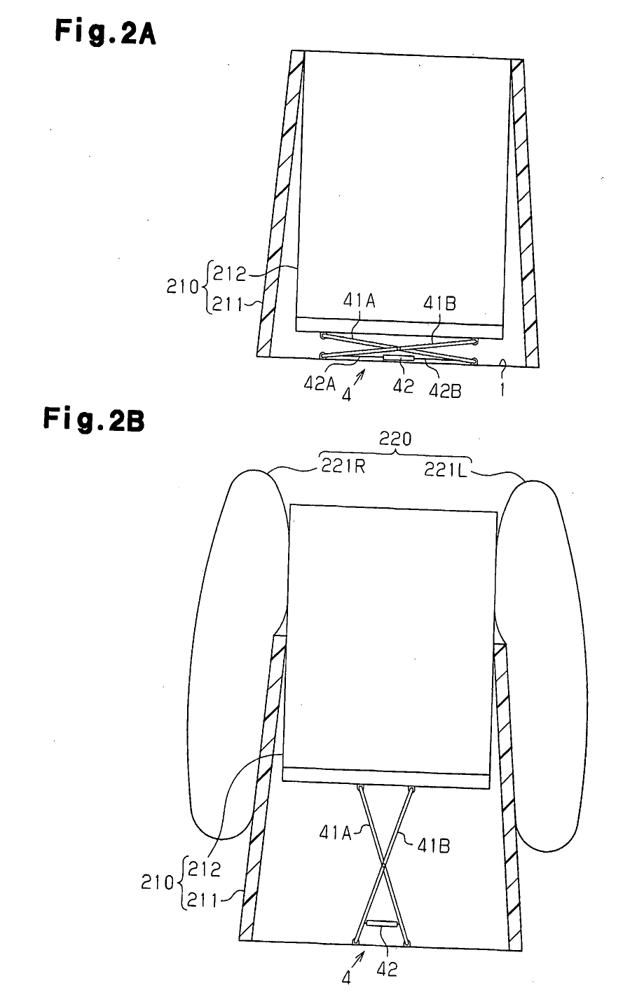

A second embodiment of the present invention will now be described with reference to FIGS. 2A and 2B. The differences from the first embodiment will be mainly discussed.

As shown in FIG. 2A and FIG. 2B, a center console 210 of a vehicle, to which an airbag apparatus of the present embodiment is mounted, includes a console main body 211, and a console box 212, which is separate from the console main body 211 and accommodated inside the console main body 211. An airbag 220 is provided in a side portion of the console main body 211.

In a vehicle collision, the console box 212 is moved upward by a moving mechanism 4, so as to pop out of the console main body 211, prior to the inflation and deployment of the airbag 220. Thus, when an occupant seated on the driver's seat 3R or the passenger seat 3L is moved in such a manner as to fall onto the center console 210 due to the impact of the collision, an upper portion of the airbag 220, which receives a particularly great pressure from the occupant, is supported by the side surface of the console box 212.

The moving mechanism 4 is located in the console main body 211 and between the floor surface 1 and the lower surface of the console box 212. The moving mechanism 4 has a pair of levers 41A, 41B, which are pivotally connected to each other at the center portions, and an actuator 42 for pivoting the levers 41A, 41B. The actuator 42 has a pair of rods 42A, 42B. One end of each rod 42A, 42B is fixed to one of the levers 41A, 41B.

The vehicle has a collision prediction device, which predicts a vehicle collision. When the collision prediction device predicts a vehicle collision, the actuator 42 is driven in response to a collision prediction signal, and the rods 42A, 42B of the actuator 42 are retracted. As a result, the levers 41A, 41B are pivoted such that the console box 212 is moved upward. Thus, a first portion 221R and a second portion 221L of the airbag 220, which are subsequently inflated and deployed, are supported not only by the side surfaces of the console main body 211, but also by the side surfaces of the console box 212.

In addition to the above described advantages of the first embodiment, the second embodiment provides the following advantages.

In a vehicle collision, the console box 212 of the center console 210 is moved upward by the moving mechanism 4, so as to pop out of the console main body 211, prior to the inflation and deployment of an airbag 220. Thus, when an occupant seated on the driver's seat 3R or the passenger seat 3L is moved in such a manner as to fall onto the center console 210 due to the impact of the collision, an upper portion of the airbag 220, which receives a particularly great pressure from the occupant, is supported by the side surface of the console box 212. The airbag 220 is therefore reliably prevented from falling.

The moving mechanism 4 moves the console box 212 when the collision prediction device predicts a vehicle collision. Therefore, the second embodiment prevents an excessive extension of the period from when a vehicle collision is detected to when the airbag 220 is inflated and deployed, which extension can be caused when the console box 212 is moved prior to the inflation and deployment of the airbag 220.

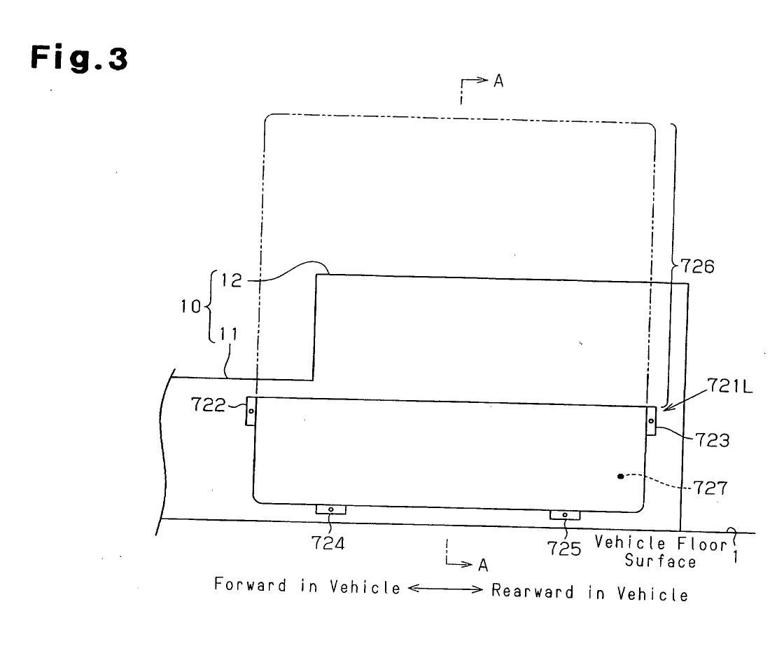

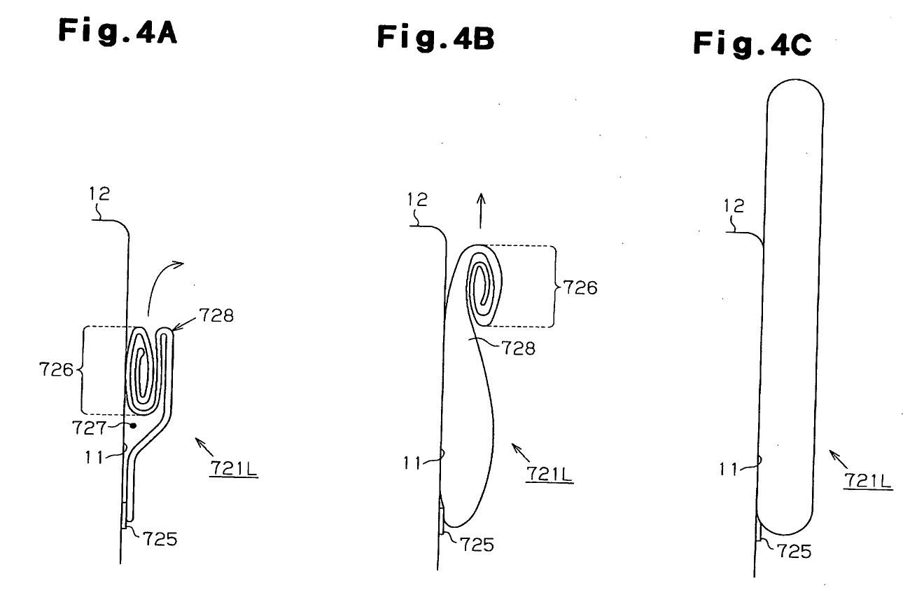

A third embodiment of the present invention will now be described with reference to FIGS. 3 to 4C.

An airbag of an airbag apparatus according the third embodiment includes a first airbag portion (not shown), which is inflated and deployed in the vicinity of a driver's seat to restrain an occupant seated on the driver's seat, and a second airbag portion 721L shown in FIGS. 3 to 4C, which is inflated and deployed in the vicinity of a passenger seat to restrain an occupant seated on the passenger seat. Since the first airbag portion and the second airbag portion 721L have a similar structure, only the second airbag portion 721L will be discussed below, and the explanation of the first airbag portion is omitted.

The second airbag portion 721L receives the supply of gas from an inflator (not shown) so as to be changed from an uninflated and undeployed state shown by solid lines in FIG. 3 to an inflated and deployed state shown by chain double-dashed lines in FIG. 3. The second airbag portion 721L is attached to a side surface of the center console 10 that faces the passenger seat in the vehicle width direction at an outer circumference of a lower portion of the second airbag portion 721L in the inflated and deployed state, specifically, at four sections, that is, a front upper attachment section 722, a rear upper attachment section 723, a front lower attachment section 724, and a rear lower attachment section 725. The front upper attachment section 722 and the rear upper attachment section 723 are located at the same height. In the second airbag portion 721L prior to the inflation and deployment, an upper portion, which is positioned at top when the second airbag portion 721L is inflated and deployed, more specifically, a free portion 726, which is a portion of the second airbag portion 721L that is located at a higher position than the front upper attachment section 722 and the rear upper attachment section 723, is accommodated, in a folded state, in a space 727 (see FIG. 4A) defined between the lower portion of the second airbag portion 721L and the side surface of the center console 10 that faces the passenger seat in the vehicle width direction.

When folding the second airbag portion 721L, the free portion 726 of the second airbag portion 721L is rolled from the upper end in such a manner that a surface of the second airbag portion 721L that faces away from the center console 10 is rolled inward. Thereafter, the free portion 726 is folded back toward a surface of the second airbag portion 721L that faces the center console 10 at a lower end 728 of the free portion 726 (see FIG. 4A). In this manner, as shown in FIG. 4A, the free portion 726 of the second airbag portion 721L prior to the inflation and deployment is accommodated in the space 727 between the lower portion of the second airbag portion 721L and the side surface of the center console 10.

When gas is supplied to the second airbag portion 721L from the inflator, the lower end 728 of the free portion 726 is eventually unfolded as shown in FIG. 4B, so that the free portion 726 pops out of the space 727. Thereafter, the further supply of gas causes the second airbag portion 721L to be inflated and deployed between the center console 10 and the passenger seat, and along the side surface of the center console 10 that faces the passenger seat in the vehicle width direction, as shown in FIG. 4C.

When folding the second airbag portion 721L, instead of rolling the free portion 726 from the upper end in such a manner that the surface of the second airbag portion 721L that faces away from the center console 10 is rolled inward, the free portion 726 may be rolled from the upper end in such a manner that the surface of the second airbag portion 721L that faces the center console 10 is rolled inward. In this case, however, the flow of gas into the free portion 726 through the lower end 728 of the free portion 726 is interrupted, which may prevent the free portion 726 from smoothly popping out of the space 727. If the free portion 726 does not pop out smoothly from the space 727, the second airbag portion 721L is not rapidly inflated and deployed.

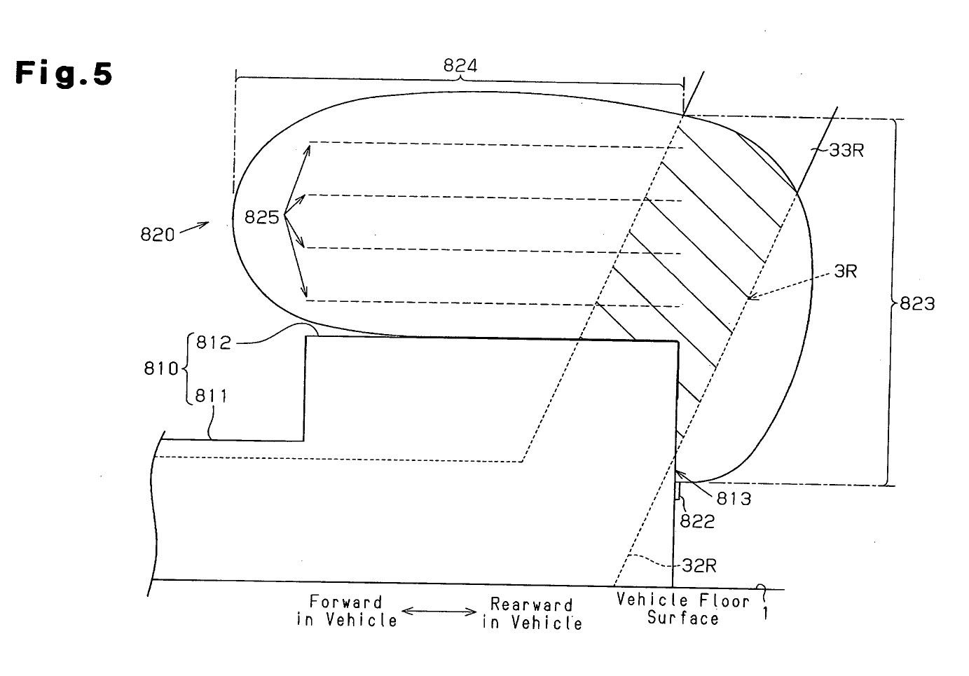

A fourth embodiment of the present invention will now be described with reference to FIG. 5.

As shown in FIG. 5, a center console 810 of a vehicle, to which an airbag apparatus of the present embodiment is mounted, includes a console main body 811, which extends along the vehicle longitudinal direction, and a console box 812, which is attached to the top of the console main body 811. An airbag 820 is attached to the rear surface 813 of the center console 810 at a proximal portion 822. An inflator (not shown), which generates gas to be supplied to the airbag 820, is located inside the center console 810.

When supplied with gas from the inflator, the airbag 820 is inflated and deployed between the seat back 33R of the driver's seat 3R and the seat back of the passenger seat (not shown). The airbag 820 has a first airbag portion 823, which is inflated and deployed behind the center console 810, and a second airbag portion 824, which is inflated and deployed above the center console 810. To prevent the second airbag portion 824 from being sharply folded back, reinforcing seams 825 are formed in the second airbag portion 824. The reinforcing seams 825 are arranged vertically at predetermined intervals. The reinforcing seams 825 extend along the vehicle longitudinal direction in such a manner as to intersect the boundary between a section of the second airbag portion 824 that faces the seat back of the passenger seat and the seat back 33R of the driver's seat 3R when the airbag 820 is inflated and deployed and a section of the second airbag portion 824 that does not face the seat backs. The reinforcing seams 825 of the second airbag portion 824 divide the interior of the second airbag portion 824 into vertically arranged cells.

The fourth embodiment has the following advantages.

The airbag 820 is inflated and deployed between the seat back 33R of driver's seat 3R and the seat back of the passenger seat. Therefore, in a vehicle collision, even if an occupant on the driver's seat 3R is moved in such a manner as to fall onto the center console 810, and as a result, applies a force in the vehicle width direction to the airbag 820, the airbag 820 is prevented from falling since the airbag 820 receives a reaction force from the seat back of the passenger seat. Likewise, in a vehicle collision, even if an occupant on the passenger seat is moved in such a manner as to fall onto the center console 810, and as a result, applies a force in the vehicle width direction to the airbag 820, the airbag 820 is prevented from falling since the airbag 820 receives a reaction force from the seat back 33R of the driver's seat 3R. Therefore, the airbag apparatus according to the present embodiment reliably restrains an occupant with the airbag 820, while preventing the airbag 820 from falling.

The reinforcing seams 825 are formed in the second portion 824 of the airbag 820. Therefore, even if an occupant on the driver's seat 3R applies a force in the vehicle width direction to the second portion 824 of the airbag 820, the second portion 824 is prevented from being folded back about a portion of the second portion 824 that is supported by the seat back of the passenger seat. Likewise, even if an occupant on the passenger seat applies a force in the vehicle width direction to the second portion 824 of the airbag 820, the second portion 824 is prevented from being folded back about a portion of the second portion 824 that is supported by the seat back 33R of the driver's seat 3R.

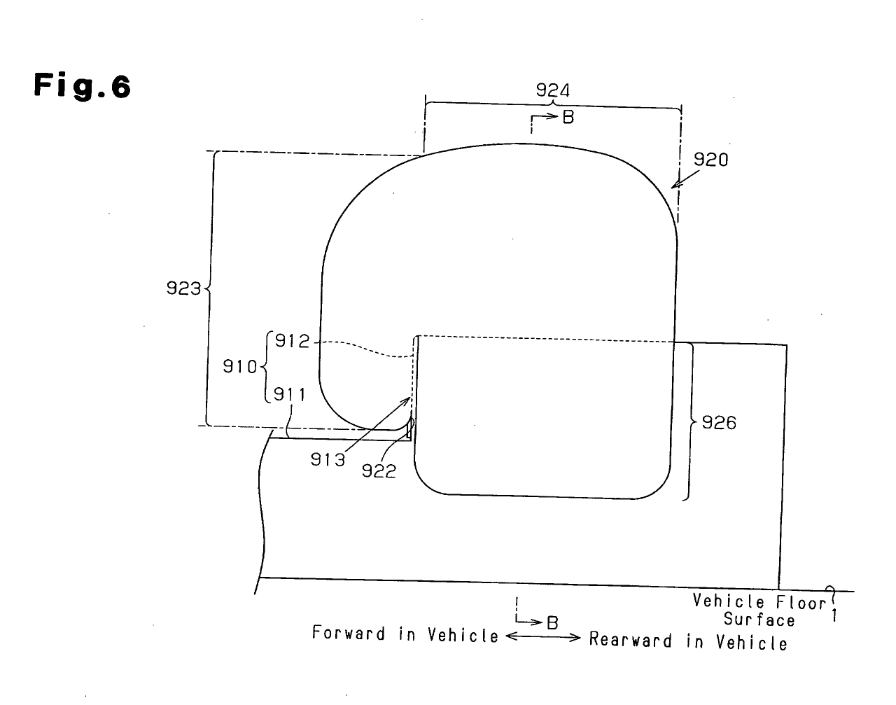

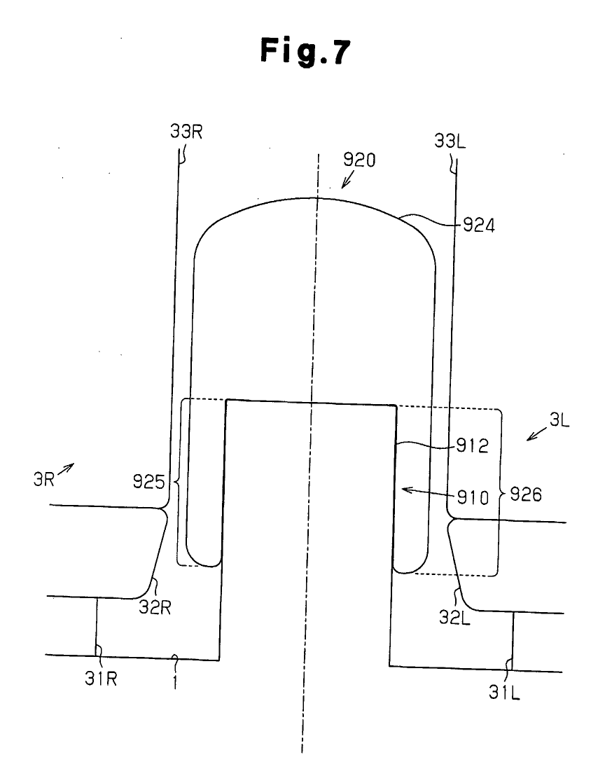

A fifth embodiment of the present invention will now be described with reference to FIGS. 6 and 7.

As shown in FIGS. 6 and 7, a center console 910 of a vehicle, to which an airbag apparatus of the present embodiment is mounted, includes a console main body 911, which extends along the vehicle longitudinal direction, and a console box 912, which is attached to the top of the console main body 911. An airbag 920 is attached to the front surface 913 of the console box 912 at a proximal portion 922. An inflator (not shown), which generates gas to be supplied to the airbag 920, is located inside the center console 910.

When supplied with gas from the inflator, the airbag 920 is inflated and deployed between the driver's seat 3R and the passenger seat 3L. The airbag 920 has a first airbag portion 923, which is inflated and deployed in front of the console box 912, a second airbag portion 924, which is inflated and deployed above the console box 912, a third airbag portion 925, which is inflated and deployed between the driver's seat 3R and the center console 910, and a fourth airbag portion 926, which is inflated and deployed between the passenger seat 3L and the center console 910.

The fifth embodiment has the following advantages.

The airbag 920 has the third airbag portion 925, which is inflated and deployed between the driver's seat 3R and the center console 910. Thus, in a vehicle collision, even if an occupant on the driver's seat 3R is moved in such a manner as to fall onto the center console 910, and as a result, applies a force in the vehicle width direction to the airbag 920, the airbag 920 is prevented from falling since the third airbag portion 925 receives a reaction force from the side surface of the center console 910 that faces the driver's seat 3R in the vehicle width direction. Also, the airbag 920 has the fourth airbag portion 926, which is inflated and deployed between the passenger seat 3L and the center console 910. Thus, in a vehicle collision, even if an occupant on the passenger seat 3L is moved in such a manner as to fall onto the center console 910, and as a result, applies a force in the vehicle width direction to the airbag 920, the airbag 920 is prevented from falling since the fourth airbag portion 926 receives a reaction force from the side surface of the center console 910 that faces the passenger seat 3L in the vehicle width direction. Therefore, the airbag apparatus according to the present embodiment reliably restrains an occupant with the airbag 920, while preventing the airbag 920 from falling.

The airbag 920 has the first airbag portion 923, which is inflated and deployed in front of the console box 912. Therefore, in a vehicle collision, even if an occupant on the driver's seat 3R or the passenger seat 3L is moved in such a manner as to fall onto the console box 912 from a position in front of the console box 912 in the vehicle longitudinal direction, the occupant is restrained by the first airbag portion 923.

The airbag 920 has the second airbag portion 924, which is inflated and deployed above the console box 912. Therefore, in a vehicle collision, even if an occupant on the driver's seat 3R or the passenger seat 3L is moved in such a manner as to fall onto the center console 910, the occupant is reliably restrained by the second airbag portion 924.

The first to fifth embodiments may be modified as follows.

In the second embodiment, the moving mechanism 4 moves the console box 212 when a vehicle collision is predicted. However, the moving mechanism 4 may move the console box 212 when a vehicle collision is detected. In this case, since the console box 212 is moved prior to the inflation and deployment of the airbag 220, the inflation and deployment of the airbag 220 can be delayed from the detection of the collision more than is necessary. To avoid such a problem, the moving mechanism 4 preferably has a high responsivity.

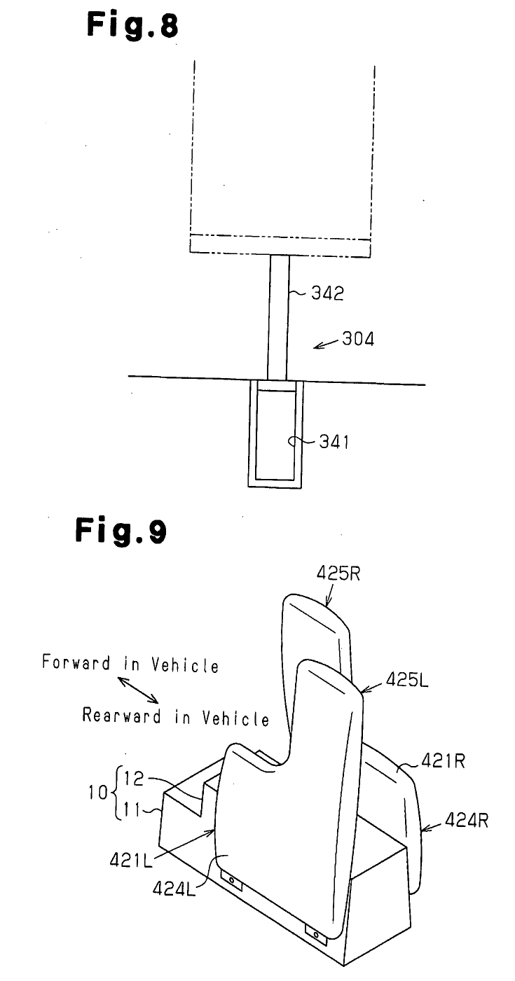

In the second embodiment, the mechanism for moving the console box 212 is not limited to the moving mechanism 4 shown in FIGS. 2A and 2B. For example, a moving mechanism 304 shown in FIG. 8 may be employed. The moving mechanism 304 has a vertically extending cylinder 341 and a rod 342, which is vertically movable in the cylinder 341. Upper movement of the 15 rod 342 may be achieved by the expansion energy of gas.

In the first to third embodiment, the airbag does not need to be bilaterally symmetrical when inflated and deployed. Specifically, the airbag may be bilaterally unsymmetrical and have a first portion located close to the driver's seat and a second portion located close to the passenger seat. The first and second portions complement each other with respect to the vehicle longitudinal direction when the airbag is inflated and deployed. For example, an airbag as shown in FIG. 9 may be employed that has a first portion 421R with an upper rear cutout and a second portion 421L with an upper front cutout. In the case of the modification shown in FIG. 9, the sizes of the first portion 421R and the second portion 421L are smaller than airbags without cutouts.

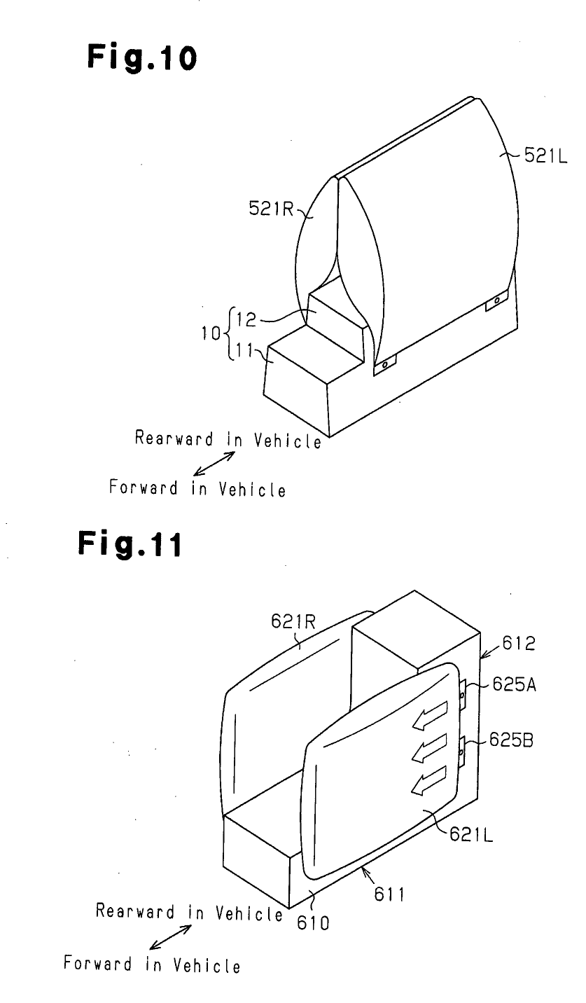

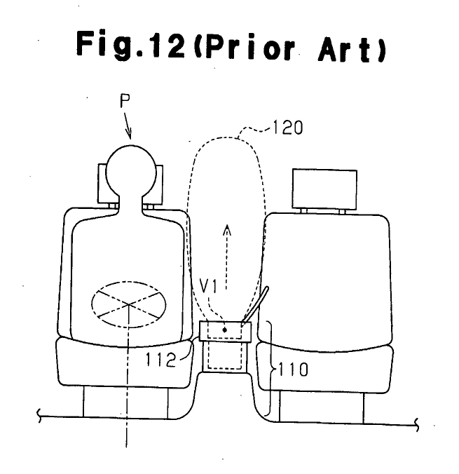

In the first to third embodiment, an airbag may be employed that has a first portion and a second portion, which are configured to have large facing areas when the airbag is inflated and deployed. For example, an airbag shown in FIG. 10 may be employed. The airbag of FIG. 10 has a first portion 521R and a second portion 521L, which are symmetrical when inflated and deployed and have large sections located above the center console 10. In the case of the modification shown in FIG. 10, when, in a vehicle collision, an occupant on the driver's seat or the passenger seat is moved in such a manner as to fall onto the center console 10, and as a result, applies a force in the vehicle width direction to the airbag, one of the first airbag portion 521R and the second airbag portion 521L receives a strong reaction force from the other.

In the first to fifth embodiments, the center console is not limited to be constructed to have a console main body and a console box. For example, the airbag apparatus according to the present invention may be employed in vehicles having an L-shaped center console, which is often used in sports vehicles. FIG. 11 shows such an L-shaped center console 610, which has a first console 611 extending along the vehicle longitudinal direction, and a second console 612 extending upward from the rear portion of the first console 611. A first airbag portion 621R is attached at its attachment sections (not shown) to a side surface of the second console 612 that faces the driver's seat in the vehicle width direction. A second airbag portion 621L is attached at its attachment sections 625A, 625B to a side surface of the second console 612 that faces the passenger seat in the vehicle width direction. In this case, the first airbag portion 621R and the second airbag portion 621L are inflated and deployed from relatively rear positions in the vehicle longitudinal direction toward the front side of the vehicle.

Alternatively, the airbag apparatus according to the present invention may be applied to a vehicle having a center console that forms a part of the instrument panel located in a front portion of the passenger compartment.

1. An airbag apparatus for a vehicle, the vehicle has in a passenger compartment a seat and a center console, which extends along a longitudinal direction of the vehicle, the apparatus comprising an airbag provided in the center console, wherein, in a collision of the vehicle, the airbag is inflated and deployed between the seat and the center console.

2. The apparatus according to claim 1, wherein the center console includes a console box having a container, a hollow portion, which is independent from the container, is provided in a portion of the center console that is located about the container, and wherein the airbag is accommodated in the hollow portion prior to inflation and deployment.

3. The apparatus according to claim 1, wherein the seat is one of a first seat and a second seat located on both sides of the center console, wherein the airbag includes a first portion that is inflated and deployed between the first seat and the center console, and a second portion that is inflated and deployed between the second seat and the center console, and wherein the first portion and the second portion of the airbag are configured to complement each other with respect to the vehicle longitudinal direction when inflated and deployed.

4. The apparatus according to claim 1, wherein the seat is one of a first seat and a second seat located on both sides of the center console, wherein the airbag includes a first portion that is inflated and deployed between the first seat and the center console, a second portion that is inflated and deployed between the second seat and the center console, and a connection portion that connects the first portion and the second portion to each other.

5. The apparatus according to claim 1, the center console includes a console main body, and a console box, which is separately formed from the console main body and accommodated inside the console main body, the apparatus further comprising a moving mechanism that, prior to the inflation and deployment of the airbag, moves the console box upward such that the console box pops out of the console main body.

6. The apparatus according to claim 5, wherein the moving mechanism moves the console box when a collision prediction device predicts a collision of the vehicle.

7. The apparatus according to claim 1, wherein the airbag has a lower portion that is located in a lower part of the airbag when the airbag is inflated and deployed, the airbag being attached to a side surface of the center console at an outer periphery of the lower portion, wherein the remainder of the airbag is a free portion, and wherein, prior to the inflation and deployment of the airbag, the free portion is accommodated in a folded state in a space defined between the lower portion of the airbag and the side surface of the center console in such a manner that the free portion is rolled from its upper end with a surface of the airbag that faces away from the center console rolled inward, and that, at a lower end of the free portion, the free portion is folded back toward a surface of the airbag that faces the center console.

8. An airbag apparatus for a vehicle, the vehicle has in a passenger compartment a center console, which extends along a longitudinal direction of the vehicle, and first and second seats, which each have a seat back and are provided on both sides of the center console, the apparatus comprising an airbag provided in the center console, wherein, in a collision of the vehicle, the airbag is inflated and deployed between the seat back of the first seat and the seat back of the second seat.

9. The apparatus according to claim 8, wherein the airbag has a reinforcing seam that intersects a boundary between a section of the airbag that faces the seat back of the first seat and the seat back of the second seat when the airbag is inflated and deployed, and a section of the airbag that does not face the seat backs.

10. The apparatus according to claim 1, wherein the center console includes a console box having a container, wherein the seat is one of a first seat and a second seat. located on both sides of the center console, wherein the airbag includes a first portion that is inflated and deployed between the first seat and the center console, a second portion that is inflated and deployed between the second seat and the center console, and a third portion that is inflated and deployed in front of the console box.

11. The apparatus according to claim 1, wherein the seat is one of a first seat and a second seat located on both sides of the center console, wherein the airbag includes a first portion that is inflated and deployed between the first seat and the center console, a second portion that is inflated and deployed between the second seat and the center console, and a third portion that is inflated and deployed above the console box.
